(19) United States
(12) Patent Application Publication
(10) Pub. No.: US 2005/0035494 A1
(43) Pub. Date: Feb. 17, 2005

(54) Three-dimensional molded blade and method for manufacturing the blade

(76) Inventor: Mao-Lin Huang, Taichung County 429 (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/637,622

(22) Filed: Aug. 11, 2003

(51) Int. Cl. B29C 43/02

(52) U.S. Cl. 264/313; 264/320; 156/245

(57) ABSTRACT

A method for manufacturing a three-dimensional molded blade includes a press molding process, a bonding process, and a cutting process. The three-dimensional molded blade comprises a three-dimensional molded layer, and a substrate mounted on a bottom of the molded layer. Thus, the molded layer forms an arch-shaped structure on the surface of the substrate, so that the molded blade has a greater structural support strength with a light weight, thereby decreasing consumption of rotational energy of the ceiling fan.

### BACKGROUND OF THE INVENTION

1. Field of the Invention

The present invention relates to a three-dimensional molded blade and the method for manufacturing the three-dimensional molded blade.

2. Description of the Related Art

A conventional blade for a ceiling fan comprises a plurality of sheet material laminated with each other. However, the conventional blade lacks variation in the shape and pattern, thereby decreasing the aesthetic quality of the conventional blade.

### SUMMARY OF THE INVENTION

The present invention is to mitigate and/or obviate the disadvantage of the conventional blade for a ceiling fan.

The primary objective of the present invention is to provide a three-dimensional molded blade and the method for manufacturing the blade, wherein the molded layer forms an arch-shaped structure on the surface of the substrate, so that the molded blade has a greater structural support strength with a light weight, thereby decreasing consumption of rotational energy of the ceiling fan.

Another objective of the present invention is to provide a three-dimensional molded blade and the method for manufacturing the blade, wherein the molded blade is manufactured by am automatic process without needing the manual work, so that the molded blade can be produced at a higher speed with a higher quality.

A further objective of the present invention is to provide a three-dimensional molded blade and the method for manufacturing the blade, wherein the molded blade can be produced rapidly, easily and conveniently without needing the manual work, thereby decreasing costs of fabrication.

A further objective of the present invention is to provide a three-dimensional molded blade and the method for manufacturing the blade, wherein the pattern of the molded layer can be changed arbitrarily by variation the shape of the cavity of the shaping mold, thereby enhancing aesthetic quality and variation of the molded blade.

In accordance with the present invention, there is provided a method for manufacturing a three-dimensional molded blade, comprising a press molding process including:
providing a shaping mold having a top formed with a three-dimensional cavity;
placing a molded layer in the shaping mold and located above the cavity;
inserting a press mold into the shaping mold; and
heat pressing the molded layer between the press mold and the shaping mold during a period of time, thereby forming a three-dimensional molded layer in the cavity of the shaping mold.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a three-dimensional molded blade in accordance with the preferred embodiment of the present invention;

FIG. 2 is a side plan cross-sectional view of the three-dimensional molded blade as shown in FIG. 1;

FIG. 3 is a flow chart of a method for manufacturing the three-dimensional molded blade in accordance with the preferred embodiment of the present invention;

FIG. 4 is a schematic cross-sectional view showing fabrication of the three-dimensional molded blade as shown in FIG. 1;

FIG. 5 is a schematic cross-sectional view showing fabrication of the three-dimensional molded blade as shown in FIG. 1;

FIG. 6 is a schematic cross-sectional view showing fabrication of the three-dimensional molded blade as shown in FIG. 1; and

FIG. 7 is a schematic cross-sectional view showing fabrication of the three-dimensional molded blade as shown in FIG. 1.

### DETAILED DESCRIPTION OF THE INVENTION

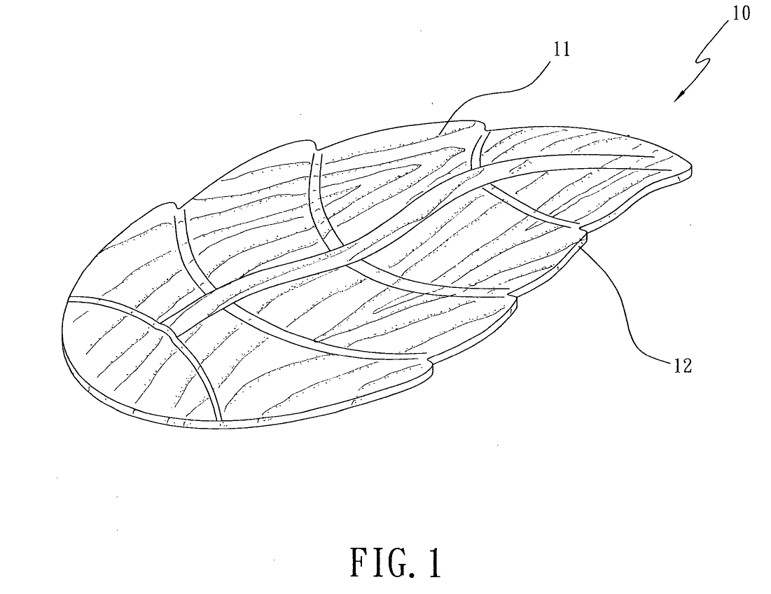

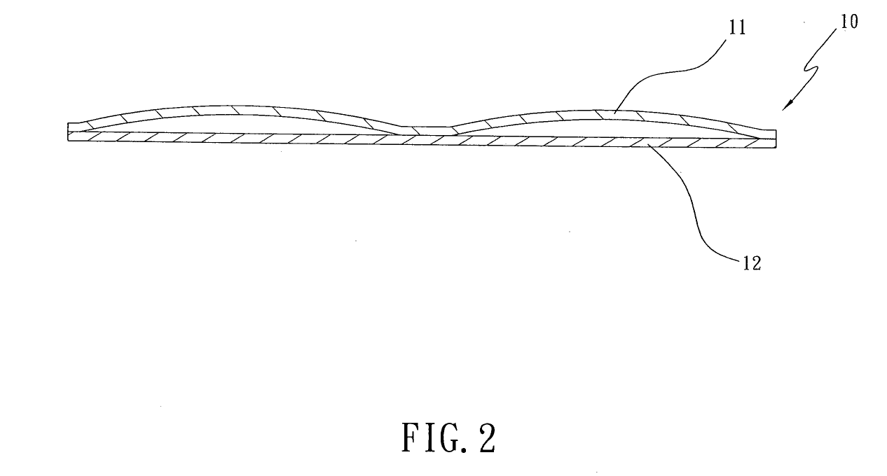

Referring to the drawings and initially to FIGS. 1 and 2, a three-dimensional molded blade 10 in accordance with the preferred embodiment of the present invention is available for a ceiling fan and comprises a three-dimensional molded layer 11, and a substrate 12 mounted on a bottom of the molded layer 11. Thus, the whole surface of the molded blade 10 produces a three-dimensional molded visible sensation.

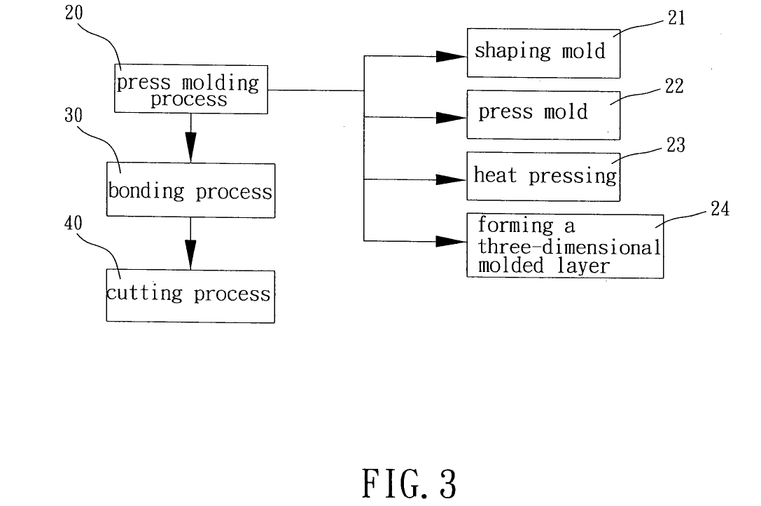

Referring to FIGS. 3-7 with reference to FIGS. 1 and 2, a method for manufacturing the molded blade 10 comprises the following steps:
press molding process 20;
bonding process 30; and
cutting process 40.

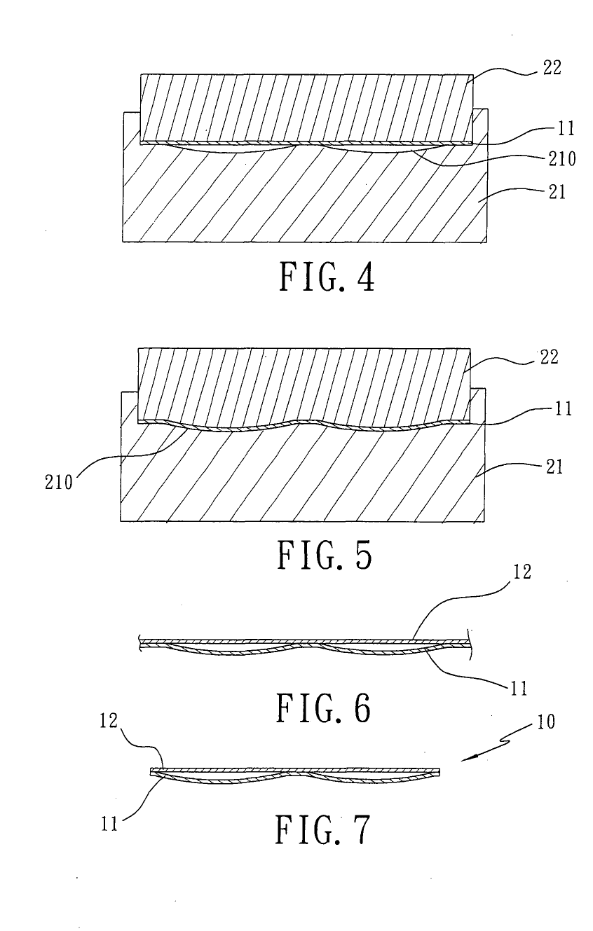

In the press molding process 20, a shaping mold 21 is provided, wherein the shaping mold 21 has a top formed with a three-dimensional cavity 210. Preferably, the shaping mold 21 is made of a flexible material, such as the rubber, and is heated to the temperature of 180° C. Then, a sheet-shaped molded layer 11 is placed in the shaping mold 21 and located above the cavity 210. Then, a press mold 22 is heated to the temperature of 100° C., and is inserted into the shaping mold 21 as shown in FIG. 4, so that the molded layer 11 is heat pressed (the step 23) between the press mold 22 and the shaping mold 21 during a period of time (about three minutes), thereby forming a three-dimensional molded layer 11 (the step 24) in the cavity 210 of the shaping mold 21 as shown in FIG. 5.

In the bonding process 30, the three-dimensional molded layer 11 is removed from the cavity 210 of the shaping mold 21, and is bonded on a substrate 12, so that the three-dimensional molded layer 11 is combined with the substrate 12 integrally as shown in FIG. 6.

In the cutting process 40, the rim of combination of the three-dimensional molded layer 11 and the substrate 12 is trimmed and cut, thereby forming a three-dimensional molded blade 10 as shown in FIG. 7, wherein the three-dimensional molded blade 10 consists of the three-dimensional molded layer 11 and the substrate 12.

Accordingly, the molded layer 11 forms an arch-shaped structure on the surface of the substrate 12 as shown in FIG. 2, so that the molded blade 10 has a greater structural support strength with a light weight, thereby decreasing consumption of rotational energy of the ceiling fan.

In addition, the molded blade 10 is manufactured by am automatic process without needing the manual work, so that the molded blade 10 can be produced at a higher speed with a higher quality.

Further, the molded blade 10 can be produced rapidly, easily and conveniently without needing the manual work, thereby decreasing costs of fabrication.

Further, the pattern of the molded layer 11 can be changed arbitrarily by variation the shape of the cavity 210 of the shaping mold 21, thereby enhancing aesthetic quality and variation of the molded blade 10.

While the preferred embodiment(s) of the present invention has been shown and described, it will be apparent to those skilled in the art that various modifications may be made in the embodiment(s) without departing from the spirit of the present invention. Such modifications are all within the scope of the present invention.

1. A method for manufacturing a three-dimensional molded blade, comprising a press molding process including:
providing a shaping mold having a top formed with a three-dimensional cavity;
placing a molded layer in the shaping mold and located above the cavity;
inserting a press mold into the shaping mold; and
heat pressing the molded layer between the press mold and the shaping mold during a period of time, thereby forming a three-dimensional molded layer in the cavity of the shaping mold.

2. The method in accordance with claim 1, wherein the molded blade comprises a three-dimensional molded layer, and a substrate mounted on a bottom of the molded layer.

3. The method in accordance with claim 1, wherein the shaping mold is made of a flexible material.

4. The method in accordance with claim 1, wherein the shaping mold is made of a rubber.

5. The method in accordance with claim 1, wherein the shaping mold is heated to the temperature of 180° C.

6. The method in accordance with claim 1, wherein the press mold is heated to the temperature of 100° C.

7. The method in accordance with claim 1, wherein the molded layer is heat pressed between the press mold and the shaping mold during about three minutes.

8. The method in accordance with claim 1, further comprising a bonding process:
removing the three-dimensional molded layer from the cavity of the shaping mold; and
bonding the three-dimensional molded layer on a substrate, so that the three-dimensional molded layer is combined with the substrate integrally.

9. The method in accordance with claim 8, further comprising a cutting process:
cutting the rim of combination of the three-dimensional molded layer and the substrate, thereby forming a three-dimensional molded blade.

10. The method in accordance with claim 8, wherein the molded layer forms an arch-shaped structure on the surface of the substrate.
